(19) United States
(12) Patent Application Publication
(10) Pub. No.: US 2025/0105295 A1
(43) Pub. Date: Mar. 27, 2025

(54) NEGATIVE ELECTRODE ACTIVE MATERIAL LAYER, NEGATIVE ELECTRODE, AND LITHIUM-ION RECHARGEABLE BATTERY

(71) Applicant: TDK Corporation, Tokyo (JP)

(72) Inventors: Hiroshi SASAGAWA, Tokyo (JP); Takashi MORI, Tokyo (JP)

(73) Assignee: TDK Corporation, Tokyo (JP)

(21) Appl. No.: 18/974,849

(22) Filed: Dec. 10, 2024

Related U.S. Application Data
(63) Continuation of application No. PCT/JP2022/024003, filed on Jun. 15, 2022.

(51) Int. Cl. H01M 4/62; H01M 4/02; H01M 4/13; H01M 4/134; H01M 4/36; H01M 4/38; H01M 4/48; H01M 10/0525

(52) U.S. Cl. CPC H01M 4/62; H01M 4/13; H01M 4/134; H01M 4/366; H01M 4/386; H01M 4/483; H01M 4/622; H01M 4/623; H01M 4/625; H01M 10/0525; H01M 2004/021; H01M 2004/027

(57) ABSTRACT

This negative electrode active material layer may contain a negative electrode active material and a fibrous material. The negative electrode active material may contain silicon. The fibrous material may contain at least one kind selected from the group consisting of titanium oxide, potassium titanate, aluminum oxide, silicon carbide, silicon nitride, and silicon oxide. The fiber length of the fibrous material may be 20 μm or more and 150 μm or less. The value obtained by dividing a thickness of the negative electrode active material layer by the fiber length may be 0.4 or more and 1.0 or less.

### CROSS-REFERENCE TO RELATED APPLICATION

The present application is a continuation of International Application No. PCT/JP2022/024003, filed Jun. 15, 2022, which is incorporated herein by reference in its entirety.

### TECHNICAL FIELD

The present disclosure relates to a negative electrode active material layer, a negative electrode, and a lithium-ion rechargeable battery.

### BACKGROUND ART

A lithium-ion rechargeable battery is widely used as a power source for a mobile device such as a mobile phone or a laptop, a hybrid car, or the like.

An active material layer containing an active material is responsible for charging and discharging a lithium-ion rechargeable battery. The internal configuration of the active material layer has been studied in order to improve the characteristics of the lithium-ion rechargeable battery.

For example, Patent Documents 1 and 2 describe an active material layer containing a filler having a predetermined shape. For example, Patent Documents 3 and 4 describe that two kinds of lithium cobaltates having tap densities different from each other are used as the active material. For example, Patent Document 5 describes an active material layer in which carbon nanofibers are added to a binder. For example, Patent Document 6 describes an active material layer in which fibrous carbon is added to a binder.

### CITATION LIST

### Patent Document

[Patent Document 1] Japanese Unexamined Patent Application, First Publication No. 2006-172901
[Patent Document 2] Japanese Unexamined Patent Application, First Publication No. 2019-186164
[Patent Document 3] United States Patent Application, Publication No. 2005/0271576
[Patent Document 4] United States Patent Application, Publication No. 2008/0087862
[Patent Document 5] United States Patent Application, Publication No. 2007/0092796
[Patent Document 6] United States Patent Application, Publication No. 2011/0266495

### SUMMARY OF DISCLOSURE

### Technical Problems

A negative electrode active material containing silicon undergoes a large volume expansion during charging. The volume expansion of the negative electrode active material causes the deterioration of the cycle characteristics of the battery. In a case where the volume expansion of the negative electrode active material occurs, for example, the conductive path between the negative electrode active material layers is cut, peeling occurs at the interface between the negative electrode active material layer and the current collector, or the decomposition or the like of the electrolytic solution occurs since the solid electrolyte interphase (SEI) coating cracks. These deteriorate the cycle characteristics of the battery. Even in a case where a silicon-based material is used as the negative electrode active material, there is a demand for a battery which is less likely to undergo deterioration in charging and discharging characteristics.

The present disclosure has been made in consideration of the above and other problems, and an object of the present disclosure is to provide a negative electrode active material layer, a negative electrode, and a lithium-ion rechargeable battery, which are less likely to undergo deterioration in charging and discharging characteristics.

### Solution to Problems

In order to solve the above and other problems, the following means according to some embodiments of the present disclosure are provided.

(1) A negative electrode active material layer according to a first aspect contains a negative electrode active material and a fibrous material. The negative electrode active material contains silicon. The fibrous material contains at least one kind selected from the group consisting of titanium oxide, potassium titanate, aluminum oxide, silicon carbide, silicon nitride, and silicon oxide. The fiber length of the fibrous material is 20 μm or more and 150 μm or less. A value obtained by dividing a layer thickness of the negative electrode active material layer by the fiber length is 0.4 or more and 1.0 or less.

(2) In the negative electrode active material layer according to the above aspect, the average interparticle distance of the negative electrode active material may be 3.0 μm or more and 4.5 μm or less.

(3) In the negative electrode active material layer according to the above aspect, the fibrous material may contain any one or more kinds selected from the group consisting of titanium oxide, potassium titanate, and aluminum oxide.

(4) A negative electrode according to a second aspect includes the negative electrode active material layer according to the above aspect.

(5) A lithium-ion rechargeable battery according to a third aspect includes the negative electrode according to the above aspect, a positive electrode facing the negative electrode, and an electrolyte connecting the negative electrode and the positive electrode.

### Advantageous Effects of Disclosure

The negative electrode active material layer, the negative electrode, and the lithium-ion rechargeable battery according to the above aspect are less likely to undergo deterioration in charging and discharging characteristics.

### BRIEF DESCRIPTION OF DRAWINGS

FIG. 1 is a schematic cross-sectional view of a lithium-ion rechargeable battery according to a first embodiment.

FIG. 2 is an enlarged schematic view of a characteristic portion of a negative electrode active material layer according to the first embodiment.

### DESCRIPTION OF EMBODIMENTS

Hereinafter, the embodiments will be described in detail with reference to the drawings as appropriate. The drawings that are used in the following description may show characteristic portions in an enlarged scale for the sake of convenience in order to facilitate the understanding of the characteristics, and thus the dimensional ratios or the like of the respective components may differ from the actual ones. The materials, dimensions, and the like, which are exemplified in the following description, are merely examples, and the present disclosure is not limited thereto. Therefore, an appropriate modification can be made within the scope that does not deviate from the gist of the present disclosure.

### “Lithium-Ion Rechargeable Battery”

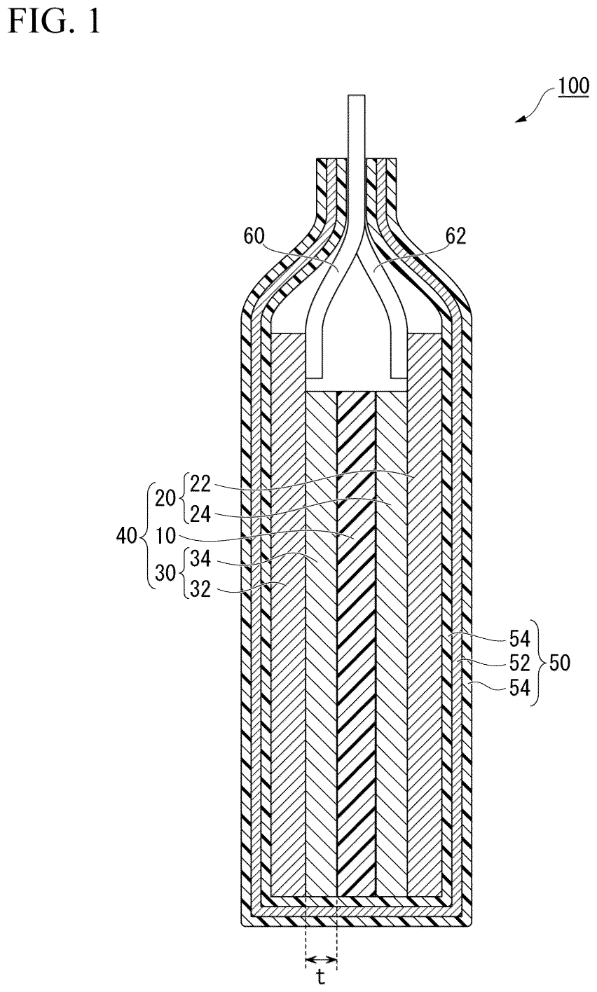

FIG. 1 is a schematic cross-sectional view of a lithium-ion rechargeable battery according to a first embodiment. A lithium-ion rechargeable battery 100 shown in FIG. 1 includes a power generation element 40, an exterior body 50, and an electrolyte (for example, a non-aqueous electrolytic solution). The exterior body 50 covers the periphery of the power generation element 40. The power generation element 40 is connected to the outside through a pair of connected terminals 60 and 62. The non-aqueous electrolytic solution is accommodated within the exterior body 50. Although FIG. 1 illustrates, as an example, a case in which one power generation element 40 is provided within the exterior body 50, a plurality of power generation elements 40 may be laminated.

### (Power Generation Element)

The power generation element 40 includes a separator 10, a positive electrode 20, and a negative electrode 30. The power generation element 40 may be a laminate in which these are laminated or may be a wound body in which a structure obtained by laminating these is wound.

### <Positive Electrode>

The positive electrode 20 has, for example, a positive electrode current collector 22 and a positive electrode active material layer 24. The positive electrode active material layer 24 is in contact with at least one surface of the positive electrode current collector 22.

### (Positive Electrode Current Collector)

The positive electrode current collector 22 is, for example, a conductive plate material. The positive electrode current collector 22 is a thin plate of a metal, for example, aluminum, copper, nickel, titanium, or stainless steel. Aluminum, which is light in weight, is preferably used for the positive electrode current collector 22. The average thickness of the positive electrode current collector 22 is, for example, 10 μm or more and 30 μm or less.

### [Positive Electrode Active Material Layer]

The positive electrode active material layer 24 contains, for example, a positive electrode active material. The positive electrode active material layer 24 may contain a conductive auxiliary agent and a binder as necessary.

The positive electrode active material layer includes an electrode active material that enables reversible absorbing and releasing of lithium ions, desorbing and inserting (intercalating) of lithium ions, or doping and dedoping of lithium ions and counter anions.

The positive electrode active material is, for example, a composite metal oxide. The composite metal oxide is, for example, lithium cobaltate (LiCoO₂), lithium nickelate (LiNiO₂), lithium manganate (LiMnO₂), and lithium manganese spinel (LiMn₂O₄), as well as a compound of a general formula: LiNiₓCo_{y}Mn_{z}MₐO₂ (in the general formula, x+y+z+a=1, 0≤x<1, 0≤y<1, 0≤z<1, and 0≤a<1 are satisfied, and M is one or more kinds of elements selected from Al, Mg, Nb, Ti, Cu, Zn, and Cr), a lithium vanadium compound (LiV₂O₅), an olivine-type LiMPO₄ (here, M represents one or more kinds of elements selected from Co, Ni, Mn, Fe, Mg, Nb, Ti, Al, and Zr, or VO), lithium titanate (Li₄Ti₅O₁₂), and LiNiₓCo_{y}Al_{z}O₂ (0.9<x+y+z<1.1). The positive electrode active material may be an organic material. For example, the positive electrode active material may be polyacetylene, polyaniline, polypyrrole, polythiophene, or polyacene.

The positive electrode active material may be a lithium-free material. The lithium-free material is, for example, FeF₃, a conjugated polymer containing an organic conductive material, a Chevrel phase compound, a transition metal chalcogenide, a vanadium oxide, or a niobium oxide. As the lithium-free material, any one material described above may be used alone, or a plurality of the materials described above may be used in combination. In a case where the positive electrode active material is a lithium-free material, for example, discharging is first carried out. Lithium is inserted into the positive electrode active material by discharging. In addition, the positive electrode active material as a lithium-free material may be pre-doped with lithium chemically or electrochemically.

The conductive auxiliary agent enhances electron conductivity between the positive electrode active materials. The conductive auxiliary agent is, for example, a carbon powder, a carbon nanotube, a carbon material, a metal fine powder, a mixture of a carbon material and a metal fine powder, or a conductive oxide. The carbon powder is, for example, carbon black, acetylene black, or Ketjen black. The fine metal powder is, for example, a powder of copper, nickel, stainless steel, or iron.

The content of the conductive auxiliary agent in the positive electrode active material layer 24 is not particularly limited. For example, with respect to the total mass of the positive electrode active material, the conductive auxiliary agent, and the binder, the content of the conductive auxiliary agent is 0.5% by mass or more and 20% by mass or less and is preferably 1% by mass or more and 5% by mass or less.

The binder in the positive electrode active material layer 24 binds the positive electrode active materials to each other. As the binder, a publicly known binder can be used. The binder is preferably such as one that is insoluble in the electrolytic solution, has oxidation resistance, and has adhesiveness. The binder is, for example, a fluororesin. The binder is, for example, polyvinylidene fluoride (PVDF), polyvinyl alcohol (PVA), polytetrafluoroethylene (PTFE), polyamide (PA), polyimide (PI), polyamideimide (PAI), polybenzimidazole (PBI), polyethersulfone (PES), a polyacrylic acid and a copolymer thereof, metal ion-crosslinked products of a polyacrylic acid and a copolymer thereof, polypropylene (PP) or polyethylene (PE) which is grafted with maleic anhydride, or a mixture thereof. The binder that is used in the positive electrode active material layer is particularly preferably PVDF.

The content of the binder in the positive electrode active material layer 24 is not particularly limited. For example, with respect to the total mass of the positive electrode active material, the conductive auxiliary agent, and the binder, the content of the binder is 1% by mass or more and 15% by mass or less and is preferably 1.5% by mass or more and 5% by mass or less. In a case where the binder content is low, the adhesion strength of the positive electrode 20 is weakened. In a case where the binder content is high, the energy density of the lithium-ion rechargeable battery 100 decreases since the binder is electrochemically inactive and thus does not contribute to the discharge capacity.

### <Negative Electrode>

The negative electrode 30 has, for example, a negative electrode current collector 32 and a negative electrode active material layer 34. The negative electrode active material layer 34 is formed on at least one surface of the negative electrode current collector 32.

### (Negative Electrode Collector)

The negative electrode current collector 32 is, for example, a conductive plate material. As the negative electrode current collector 32, the same one as in the positive electrode current collector 22 can be used.

### [Negative Electrode Active Material Layer]

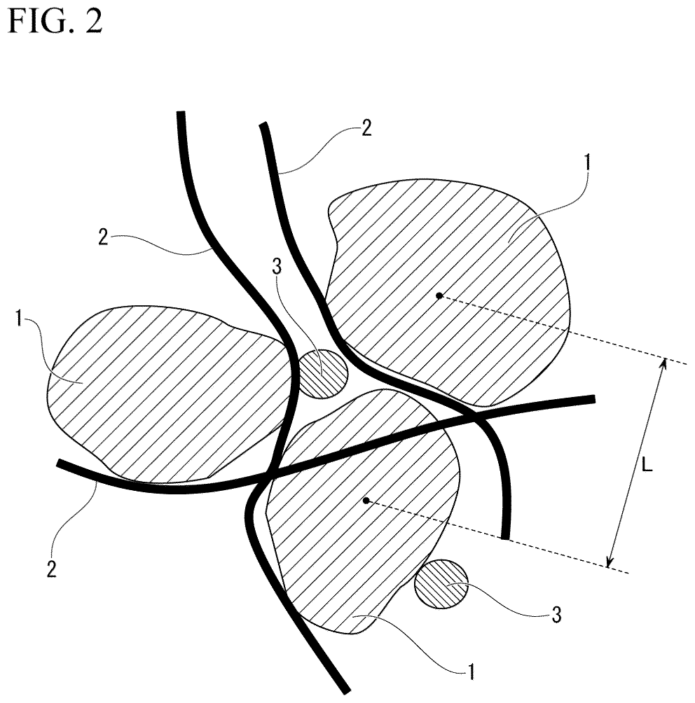

FIG. 2 is an enlarged schematic view of a characteristic portion of the negative electrode active material layer 34. The negative electrode active material layer 34 includes, for example, a negative electrode active material 1, a fibrous material 2, a conductive auxiliary agent 3, and a binder (not illustrated in the drawing). The negative electrode active material layer 34 may further contain another substance such as a dispersion stabilizer.

The negative electrode active material 1 contains silicon. The negative electrode active material 1 may be any of silicon as a simple body, a silicon alloy, a silicon compound, and a silicon composite body. The negative electrode active material 1 may be crystalline or amorphous.

The silicon alloy is represented by, for example, XₙSi. X is a cation. X is, for example, Ba, Mg, Al, Zn, Sn, Ca, V, Cr, Mn, Fe, Co, Ni, Cu, Zn, Ge, Y, Zr, Nb, Mo, W, Au, Ti, Na, or K. n satisfies 0<n<0.5.

The silicon compound is, for example, silicon oxide denoted as SiOₓ. x satisfies, for example, 0.8≤x≤2. The silicon oxide may consist of only SiO₂, may consist of only SiO, or may be a mixture of SiO and SiO₂. In addition, the silicon oxide may be such that some oxygen is deficient.

The silicon composite body is, for example, such as one that is obtained by coating, with a conductive material, at least a part of the surface of the particle of silicon or a silicon compound. The conductive material is, for example, a carbon material, Al, Ti, Fe, Ni, Cu, Zn, Ag, or Sn. For example, one example thereof is a silicon carbon composite material (Si—C).

The average interparticle distance L of the negative electrode active material 1 is, for example, 3.0 μm or more and 4.5 μm or less. The average interparticle distance L can be measured with a scanning electron microscope (SEM). In a case of determining the average interparticle distance L, first, an SEM image magnified 1,000 times to 1,500 times is subjected to measurement in three fields of view. Then, in each of the three visual fields, the distance between the geometric centers of adjacent negative electrode active materials 1 is measured at 50 points. Then, the average value of the measured interparticle distances at a total of 150 points is determined to obtain the average interparticle distance L.

The average particle diameter of the negative electrode active material 1 is, for example, 0.1 μm or more and 10 μm or less, preferably 0.5 μm or more and 8 μm or less, and more preferably 1 μm or more and 7 μm or less. The average particle diameter of the negative electrode active material 1 is also determined as the average value of particle diameters at 150 points, where the particle diameters are measured with a scanning microscope in the same manner as in the average interparticle distance L of the negative electrode active material 1.

The fibrous material 2 is a linear particle having shape anisotropy. The fibrous material 2 contains, for example, at least one kind selected from the group consisting of titanium oxide, potassium titanate, aluminum oxide, silicon carbide, silicon nitride, and silicon oxide. The fibrous material 2 includes, for example, a material different from the negative electrode active material 1. Since the silicon-based material may expand and contract in the same manner as in the case of the negative electrode active material 1, it is preferable that the fibrous material 2 contain any one or more kinds selected from the group consisting of titanium oxide, potassium titanate, and aluminum oxide.

The fiber length of the fibrous material 2 is, for example, 20 μm or more and 150 μm or less. The fiber length of the fibrous material 2 can be determined by the following procedure. First, the lithium-ion rechargeable battery 100 is disassembled, and the negative electrode 30 is taken out. Next, the negative electrode 30 is immersed, for one hour, in a solvent that is capable of dissolving a binder constituting the negative electrode active material layer 34. For example, in a case where the binder is a polyimide resin, eSolve 21KZE-100, manufactured by KANEKO CHEMICAL CO., LTD. is used. Next, the solvent is subjected to filtration and washing a plurality of times, and the powder remaining on the filter paper is dried. The powder after drying contains the negative electrode active material 1, the fibrous material 2, and the conductive auxiliary agent 3. The fibrous material 2 can be identified from the powder by carrying out mapping using energy dispersive X-ray spectroscopy (EDS). Then, the size of the identified fibrous material 2 is measured using a scanning electron microscope. In the same manner as in the case of the average interparticle distance L, the size of the fibrous material 2 is determined as the average value of the material diameters measured at 150 points using a scanning microscope.

In addition, in a case where the particle size distribution of the dried powder particles is measured using a particle size distribution analyzer (for example, manufactured by Malvern Panalytical Ltd.), a particle size distribution of the dried powder is obtained. The particle size distribution of the dried powder has two or more peaks. One of the peaks is due to the fibrous material 2, and the value thereof is in the vicinity of the fiber length of the fibrous material 2. In addition, one of the peaks is due to the negative electrode active material 1, and the value thereof is in the vicinity of the particle diameter of the negative electrode active material 1. Since the particle diameter of the negative electrode active material 1 differs from the particle diameter of the fibrous material 2, the particle size distribution of the powder has a plurality of peaks. In a case where both the fibrous material 2 and the negative electrode active material 1 contain silicon, the presence or absence of the fibrous material 2 can be checked by measuring the particle size distribution of the powder.

The fibrous material 2 preferably accounts for 20% or less of the total mass of the negative electrode active material layer 34. In addition, the fibrous material 2 preferably accounts for 1% or more of the total mass of the negative electrode active material layer 34.

The thickness t (see FIG. 1) of the negative electrode active material layer 34 is, for example, 8 μm or more and 150 μm or less. The value obtained by dividing the layer thickness t of the negative electrode active material layer 34 by the fiber length of the fibrous material 2 is, for example, 0.4 or more and 1.0 or less. In a case where the length of the fiber length of the fibrous material 2 is sufficient with respect to the layer thickness t of the negative electrode active material layer 34, the fibrous material 2 functions as a skeleton of the negative electrode active material layer 34, and thus it is possible to suppress the cracking of the negative electrode active material layer 34 during charging and discharging.

As the conductive auxiliary agent 3 and the binder, the same one as in the positive electrode 20 can be used. The binder in the negative electrode 30 may be, in addition to those exemplified for the positive electrode 20, for example, cellulose, styrene-butadiene rubber, ethylene-propylene rubber, a polyimide resin, a polyamide-imide resin, or an acrylic resin. The cellulose may be, for example, carboxymethyl cellulose (CMC).

### <Separator>

The separator 10 is sandwiched between the positive electrode 20 and the negative electrode 30. The separator 10 separates the positive electrode 20 from the negative electrode 30 and prevents a short circuit between the positive electrode 20 and the negative electrode 30. The separator 10 extends in-plane along the positive electrode 20 and the negative electrode 30. Lithium ions can pass through the separator 10.

The separator 10 has, for example, a porous structure having electrical insulating properties. The separator 10 is, for example, a single layered body or laminate of a polyolefin film. The separator 10 may be a stretched film of a mixture of polyethylene, polypropylene, and the like. The separator 10 may be a fibrous nonwoven fabric consisting of at least one constitutional material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide-based solid electrolyte, or a sulfide-based solid electrolyte. The separator 10 may be an inorganic coated separator. The inorganic coated separator is such as one that is obtained by coating the surface of the above-described film with a mixture of a resin such as PVDF or CMC and an inorganic substance such as alumina or silica. The inorganic coated separator has an excellent heat resistance and suppresses the precipitation of transition metals eluted from the positive electrode, onto the surface of the negative electrode.

### <Electrolytic Solution>

The electrolytic solution is enclosed in the exterior body 50, and the power generation element 40 is impregnated with the electrolytic solution. The electrolytic solution is not limited to a liquid electrolyte but may be a solid electrolyte. The non-aqueous electrolytic solution contains, for example, a non-aqueous solvent and an electrolytic salt. The electrolytic salt is dissolved in a non-aqueous solvent.

The solvent is not particularly limited as long as it is a solvent that is generally used in lithium-ion rechargeable batteries. The solvent includes, for example, any of a cyclic carbonate compound, a chain-like carbonate compound, a cyclic ester compound, or a chain-like ester compound. The solvent may contain these compounds in any mixture ratio. The cyclic carbonate compound is, for example, ethylene carbonate (EC), propylene carbonate (PC), fluoroethylene carbonate, or vinylene carbonate. The chain-like carbonate compound is, for example, diethyl carbonate (DEC) or ethyl methyl carbonate (EMC). The cyclic ester compound is, for example, γ-butyrolactone. The chain-like ester compound is, for example, propyl propionate, ethyl propionate, or ethyl acetate.

The electrolytic salt is, for example, a lithium salt. The electrolyte is, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, or LiN(FSO₂)₂. One kind of lithium salt may be used alone, or two or more thereof may be used in combination. From the viewpoint of the degree of ionization, the electrolyte preferably contains LiPF₆. The dissociation rate of the electrolytic salt in a carbonate solvent at room temperature is preferably 10% or more.

It is preferable that the electrolytic solution is, for example, such as one that is obtained by dissolving LiPF₆ in a carbonate solvent. The concentration of LiPF₆ is, for example, 1 mol/L. In a case where the polyimide resin contains a large amount of aromatics, the polyimide resin may exhibit charging behavior similar to that of soft carbon. In a case where the electrolytic solution is such an electrolytic solution that uses a carbonate including a cyclic carbonate as a solvent, lithium can be reacted uniformly with the polyimide. In this case, the cyclic carbonate is preferably ethylene carbonate, fluoroethylene carbonate, or vinylene carbonate.

### <Exterior Body>

The exterior body 50 seals, in the inside thereof, the power generation element 40 and the non-aqueous electrolytic solution. The exterior body 50 suppresses the leakage of the non-aqueous electrolytic solution to the outside, the infiltration of moisture or the like into the lithium-ion rechargeable battery 100 from the outside, and the like.

As shown in FIG. 1, the exterior body 50 has, for example, a metal foil 52 and a resin layer 54 laminated on each side of the metal foil 52. The exterior body 50 is a metal laminate film that is obtained by coating the metal foil 52 on both sides with a polymer film (resin layer 54).

As the metal foil 52, for example, an aluminum foil can be used. For the resin layer 54, a polymer film such as polypropylene can be used. The material constituting the resin layer 54 may be different between the inner side and the outer side. For example, as a material for the outer side, a polymer having a high melting point, for example, polyethylene terephthalate (PET) or polyamide (PA) can be used, and as a material of the polymer film for the inner side, polyethylene (PE), polypropylene (PP), or the like can be used.

### <Terminal>

The terminals 60 and 62 are connected to the positive electrode 20 and the negative electrode 30, respectively. The terminal 60 connected to the positive electrode 20 is a positive electrode terminal, and the terminal 62 connected to the negative electrode 30 is a negative electrode terminal. The terminals 60 and 62 are responsible for electrical connection to the outside. The terminals 60 and 62 are formed from a conductive material such as aluminum, nickel, copper, or the like. The connection method may be welding or screwing. The terminals 60 and 62 are preferably protected with an insulating tape to prevent short circuits.

The lithium-ion rechargeable battery 100 is produced by producing the negative electrode 30, the positive electrode 20, the separator 10, the electrolytic solution, and the exterior body 50, and then assembling them. Hereinafter, one example of a manufacturing method for the lithium-ion rechargeable battery 100 will be described.

The negative electrode 30 is produced, for example, by sequentially carrying out a slurry preparation step, an electrode application step, a drying step, and a rolling step.

The slurry preparation step is a step of mixing the negative electrode active material 1, the fibrous material 2, the conductive auxiliary agent 3, a binder, and a solvent to produce a slurry. In a case where a dispersion stabilizer is added to the slurry, it is possible to suppress the aggregation of the negative electrode active material. The solvent is, for example, water or N-methyl-2-pyrrolidone.

The electrode coating step is a step of coating the surface of the negative electrode current collector 32 with a slurry. The coating method for the slurry is not particularly limited. For example, a slit die coating method or a doctor blade method can be used as the coating method for the slurry. The slurry is applied, for example, at room temperature.

The drying step is a step of removing a solvent from the slurry. For example, the negative electrode current collector 32 on which the slurry is applied is dried in an atmosphere at 80° C. to 350° C.

The rolling step is carried out as necessary. The rolling step is a step of applying pressure to the negative electrode active material layer 34 to adjust the density of the negative electrode active material layer 34. The rolling step is carried out, for example, using a roll press device. In a case where the rolling process is carried out, the layer thickness of the negative electrode active material layer 34 can be adjusted.

The positive electrode 20 can be produced according to the same procedure as in the negative electrode 30. As the separator 10 and the exterior body 50, commercially available ones can be used.

Next, the produced positive electrode 20 and negative electrode 30 are laminated so that the separator 10 is located between them, whereby the power generation element 40 is produced. In a case where the power generation element 40 is a wound body, the positive electrode 20, the negative electrode 30, and the separator 10 are wound around with one end side thereof as an axis.

Finally, the power generation element 40 is enclosed in the exterior body 50. The non-aqueous electrolytic solution is injected into the exterior body 50. After the non-aqueous electrolytic solution is injected, decompression, heating, or the like is carried out to impregnate the power generation element 40 with the non-aqueous electrolytic solution. Heat or the like is applied to seal the exterior body 50, whereby the lithium-ion rechargeable battery 100 is obtained. It is noted that instead of injecting the electrolytic solution into the exterior body 50, the power generation element 40 may be immersed in the electrolytic solution. It is preferable to allow it to stand for 24 hours after the injection of liquid into the power generation element.

In the lithium-ion rechargeable battery 100 according to the first embodiment, the negative electrode active material layer 34 has the fibrous material 2, and thus the charging and discharging characteristics are less likely to deteriorate. This is conceived to be because the fibrous material 2 functions as a skeleton of the negative electrode active material layer 34 and prevents the cracking of the negative electrode active material layer 34 during charging and discharging. Cracking of the negative electrode active material layer 34 blocks the conductive path in the negative electrode active material layer 34. Since the negative electrode active material layer 34 is less likely to crack, the conductive path in the negative electrode active material layer 34 is maintained, and the charging and discharging characteristics of the lithium-ion rechargeable battery 100 are less likely to deteriorate.

As described above, the embodiments of the present disclosure have been described in detail with reference to the drawings. However, Each of the configurations and the combination thereof in each embodiment are examples, and additions, omissions, substitutions, and other modifications of the configuration can be made without departing from the spirit of the present disclosure.

### EXAMPLES

### Example 1

A positive electrode slurry was applied onto one surface of an aluminum foil having a thickness of 15 μm. The positive electrode slurry was produced by mixing a positive electrode active material, a conductive auxiliary agent, a binder, and a solvent.

LiₓCoO₂ was used as the positive electrode active material. Acetylene black was used as the conductive auxiliary agent. Polyvinylidene fluoride (PVDF) was used as the binder. N-methyl-2-pyrrolidone was used as the solvent. 97 parts by mass of the positive electrode active material, 1 part by mass of the conductive auxiliary agent, 2 parts by mass of the binder, and 70 parts by mass of the solvent were mixed to produce the positive electrode slurry. The amount of the positive electrode active material carried in the positive electrode active material layer after drying was set to 25 mg/cm². The solvent was removed from the positive electrode slurry in the drying furnace to create a positive electrode active material layer. The positive electrode active material layer was pressurized with a roll press to produce a positive electrode.

Next, the negative electrode slurry was applied onto one surface of a copper foil having a thickness of 10 μm. The negative electrode slurry was produced by mixing a negative electrode active material, acicular particles, a conductive auxiliary agent, a binder, and a solvent.

Silicon particles were used as the negative electrode active material. The silicon particles had an average particle diameter of 3.0 μm. Titanium oxide was used as the fibrous material. The fibrous material had a fiber length of 20 μm. Carbon black was used as the conductive auxiliary agent. A polyimide resin was used as the binder. N-methyl-2-pyrrolidone was used as the solvent. 78 parts by mass of the silicon particles, 2 parts by mass of the acicular particles, 5 parts by mass of the conductive auxiliary agent, and 15 parts by mass of the binder were mixed in N-methyl-2-pyrrolidone to produce the negative electrode slurry. The amount of the negative electrode active material carried in the negative electrode active material layer after drying was set to 1.5 mg/cm². The negative electrode active material layer was pressurized with a roll press and then baked in a nitrogen atmosphere at 300° C. or higher for 5 hours. The thickness of the negative electrode active material layer after baking was 8 μm.

Next, an electrolytic solution was produced. A solvent for the electrolytic solution was set to fluoroethylene carbonate (FEC):ethylene carbonate (EC):diethyl carbonate (DEC)=10% by volume:20% by volume:70% by volume. In addition, an additive for improving output, an additive for gas suppression, an additive for cycle characteristic improvement, an additive for safety performance improvement, and the like were added to the electrolytic solution. LiPF₆ was used as the electrolytic salt. The concentration of LiPF₆ was set to 1 mol/L.

### (Production of Lithium-Ion Rechargeable Battery for Evaluation)

The produced negative electrode and positive electrode were laminated with a separator (porous polyethylene sheet) interposed between them so that the positive electrode active material layer and the negative electrode active material layer faced each other, whereby a laminate was obtained. This laminate was inserted into an exterior body made of an aluminum laminate film, and the exterior body was subjected to heat sealing except for one place on the periphery thereof, whereby a hole-closing part was formed. Then, finally, the electrolytic solution was injected into the exterior body, and then the remaining one place was subjected to heat sealing while carrying out decompression with a vacuum sealer, whereby a lithium-ion rechargeable battery was produced. The produced lithium-ion rechargeable battery was allowed to stand for 24 hours.

(Measurement of Capacity Retention Rate after 100 Cycles)

The cycle characteristics of the lithium-ion rechargeable battery were measured. The cycle characteristics were measured using a secondary battery charging and discharging test device (manufactured by HOKUTO DENKO Corporation).

Charging was carried out by a constant current charging at a charging rate of 0.5 C (a current value at which charging is completed in 1 hour in a case where constant current charging is carried out at 25° C.) until the battery voltage reached 4.2 V, and then discharging was carried out by a constant current discharging at a discharging rate of 1.0 C until the battery voltage reached 2.5 V The discharge capacity after the completion of the charging and discharging was detected to determine a battery capacity Q₁ before the cycle test.

Regarding the battery of which the battery capacity Q₁ had been determined as above, using again the secondary battery charging and discharging test device, charging was carried out by a constant current charging at a charging rate of 0.5 C until the battery voltage reached 4.2 V, and then discharging was carried out by a constant current discharging at a discharging rate of 0.5 C until the battery voltage reached 2.5 V. The above-described charging and discharging were counted as one cycle, and 100 cycles of charging and discharging were carried out. Thereafter, the discharge capacity after the completion of the 100 cycles of charging and discharging was detected to determine a battery capacity Q₂ after 100 cycles.

From the capacities Q₁ and Q₂ obtained as above, the capacity retention rate after 100 cycles was calculated. The capacity retention rate E is calculated according to E=Q₂/Q₁×100. The capacity retention rate of Example 1 was 90%.

Then, the lithium-ion rechargeable battery after charging and discharging was disassembled, and the rate of change in the thickness of the negative electrode active material layer was determined. The rate of change in the thickness of the negative electrode active material layer is calculated according to “(thickness after charge)−(thickness after discharge)”/(thickness after discharge)×100. The rate of change was 55% in Example 1. In addition, a cross section of the negative electrode active material layer after the disassembling was measured to determine the distance between the negative electrode active materials. In Example 1, the average interparticle distance between the negative electrode active materials was 2.9 μm.

### Examples 2 to 44 and Comparative Examples 1 to 16

Examples 2 to 44 and Comparative Examples 1 to 16 differ from Example 1 in that any of the kind of material constituting the fibrous material, the fiber length of the fibrous material, the layer thickness of the negative electrode active material layer, or the average interparticle distance between the negative electrode active materials was changed. The points of change are summarized in Table 1 to Table 3. The capacity retention rate and the like of Examples 2 to 44 and Comparative Examples 1 to 16 were measured with other conditions being the same as in Example 1.

TABLE 1

| | | | | | Negative | | |
|---|---|---|---|---|---|---|---|
| | | | Negative electrode active | | electrode | | |
| | | | material layer | | active | Characteristics | |
| | Fibrous material | | Film | Film | material | | Change in |
| | | Fiber length | thickness | thickness/fiber | Interparticle | Capacity | thickness of |
| | Substance | (μm) | (μm) | length | distance (μm) | retention rate | electrode |
| Example 1 | Titanium | 20 | 8 | 0.4 | 2.9 | 90% | 55% |
| | oxide | | | | | | |
| Example 2 | Titanium | 20 | 14 | 0.7 | 2.9 | 91% | 55% |
| | oxide | | | | | | |
| Example 3 | Titanium | 20 | 20 | 1 | 2.9 | 89% | 56% |
| | oxide | | | | | | |
| Example 4 | Titanium | 60 | 24 | 0.4 | 2.9 | 88% | 57% |
| | oxide | | | | | | |
| Example 5 | Titanium | 60 | 42 | 0.7 | 2.9 | 90% | 55% |
| | oxide | | | | | | |
| Example 6 | Titanium | 60 | 60 | 1 | 2.9 | 89% | 56% |
| | oxide | | | | | | |
| Example 7 | Titanium | 100 | 40 | 0.4 | 2.9 | 90% | 55% |
| | oxide | | | | | | |
| Example 8 | Titanium | 100 | 70 | 0.7 | 2.9 | 91% | 54% |
| | oxide | | | | | | |
| Example 9 | Titanium | 100 | 100 | 1 | 2.9 | 90% | 55% |
| | oxide | | | | | | |
| Example | Titanium | 150 | 60 | 0.4 | 2.9 | 89% | 54% |
| 10 | oxide | | | | | | |
| Example | Titanium | 150 | 105 | 0.7 | 2.9 | 88% | 56% |
| 11 | oxide | | | | | | |
| Example | Titanium | 150 | 150 | 1 | 2.9 | 88% | 55% |
| 12 | oxide | | | | | | |
| Example | Silicon | 20 | 8 | 0.4 | 2.9 | 92% | 53% |
| 13 | carbide | | | | | | |
| Example | Silicon | 20 | 20 | 1 | 2.9 | 90% | 55% |
| 14 | carbide | | | | | | |
| Example | Silicon | 150 | 60 | 0.4 | 2.9 | 90% | 55% |
| 15 | carbide | | | | | | |
| Example | Silicon | 150 | 150 | 1 | 2.9 | 91% | 54% |
| 16 | carbide | | | | | | |
| Example | Silicon | 20 | 8 | 0.4 | 2.9 | 90% | 55% |
| 17 | carbide | | | | | | |
| Example | Silicon | 20 | 20 | 1 | 2.9 | 92% | 53% |
| 18 | carbide | | | | | | |
| Example | Silicon | 150 | 60 | 0.4 | 2.9 | 90% | 55% |
| 19 | carbide | | | | | | |
| Example | Silicon | 150 | 150 | 1 | 2.9 | 92% | 53% |
| 20 | carbide | | | | | | |

TABLE 2

| | | | | | Negative | | |
|---|---|---|---|---|---|---|---|
| | | | | | electrode | | |
| | | | Negative electrode active | | active | | |
| | | | material layer | | material | Characteristics | |
| | Fibrous material | | Film | Film | Interparticle | Capacity | Change in |
| | | Fiber length | thickness | thickness/fiber | distance | retention | thickness of |
| | Substance | (μm) | (μm) | length | (μm) | rate | electrode |
| Example 21 | Potassium | 20 | 8 | 0.4 | 2.9 | 90% | 55% |
| | titanate | | | | | | |
| Example 22 | Potassium | 20 | 20 | 1 | 2.9 | 90% | 55% |
| | titanate | | | | | | |
| Example 23 | Potassium | 150 | 60 | 0.4 | 2.9 | 91% | 54% |
| | titanate | | | | | | |
| Example 24 | Potassium | 150 | 150 | 1 | 2.9 | 90% | 55% |
| | titanate | | | | | | |
| Example 25 | Silicon oxide | 20 | 8 | 0.4 | 2.9 | 88% | 57% |
| Example 26 | Silicon oxide | 20 | 20 | 1 | 2.9 | 90% | 55% |
| Example 27 | Silicon oxide | 150 | 60 | 0.4 | 2.9 | 88% | 56% |
| Example 28 | Silicon oxide | 150 | 150 | 1 | 2.9 | 90% | 55% |
| Example 29 | Aluminum | 20 | 8 | 0.4 | 2.9 | 89% | 56% |
| | oxide | | | | | | |
| Example 30 | Aluminum | 20 | 20 | 1 | 2.9 | 90% | 55% |
| | oxide | | | | | | |
| Example 31 | Aluminum | 150 | 60 | 0.4 | 2.9 | 88% | 56% |
| | oxide | | | | | | |
| Example 32 | Aluminum | 150 | 150 | 1 | 2.9 | 90% | 55% |
| | oxide | | | | | | |
| Example 33 | Titanium | 40 | 24 | 0.6 | 3 | 95% | 50% |
| | oxide | | | | | | |
| Example 34 | Silicon | 40 | 24 | 0.6 | 3 | 94% | 51% |
| | carbide | | | | | | |
| Example 35 | Silicon | 40 | 24 | 0.6 | 3 | 95% | 50% |
| | nitride | | | | | | |
| Example 36 | Potassium | 40 | 24 | 0.6 | 3 | 95% | 50% |
| | titanate | | | | | | |
| Example 37 | Silicon oxide | 40 | 24 | 0.6 | 3 | 95% | 50% |
| Example 38 | Aluminum | 40 | 24 | 0.6 | 3 | 96% | 49% |
| | oxide | | | | | | |
| Example 39 | Titanium | 40 | 24 | 0.6 | 4.5 | 95% | 50% |
| | oxide | | | | | | |
| Example 40 | Silicon | 40 | 24 | 0.6 | 4.5 | 94% | 51% |
| | carbide | | | | | | |

TABLE 3

| | | | | | Negative | | |
|---|---|---|---|---|---|---|---|
| | | | | | electrode | | |
| | | | Negative electrode active | | active | | |
| | | | material layer | | material | Characteristics | |
| | Fibrous material | | Film | Film | Interparticle | Capacity | Change in |
| | | Fiber length | thickness | thickness/fiber | distance | retention | thickness of |
| | Substance | (μm) | (μm) | length | (μm) | rate | electrode |
| Example 41 | Silicon | 40 | 24 | 0.6 | 4.5 | 95% | 50% |
| | nitride | | | | | | |
| Example 42 | Potassium | 40 | 24 | 0.6 | 4.5 | 96% | 49% |
| | titanate | | | | | | |
| Example 43 | Silicon oxide | 40 | 24 | 0.6 | 4.5 | 95% | 50% |
| Example 44 | Aluminum | 40 | 24 | 0.6 | 4.5 | 96% | 49% |
| | oxide | | | | | | |
| Comparative | Carbon fiber | 20 | 8 | 0.4 | 2.9 | 80% | 60% |
| Example 1 | | | | | | | |
| Comparative | Carbon fiber | 20 | 20 | 1 | 2.9 | 81% | 59% |
| Example 2 | | | | | | | |
| Comparative | Carbon fiber | 150 | 60 | 0.4 | 2.9 | 79% | 61% |
| Example 3 | | | | | | | |
| Comparative | Carbon fiber | 150 | 150 | 1 | 2.9 | 80% | 60% |
| Example 4 | | | | | | | |
| Comparative | Cu whisker | 20 | 8 | 0.4 | 2.9 | 78% | 62% |
| Example 5 | | | | | | | |
| Comparative | Cu whisker | 20 | 20 | 1 | 2.9 | 80% | 60% |
| Example 6 | | | | | | | |
| Comparative | Cu whisker | 150 | 60 | 0.4 | 2.9 | 77% | 63% |
| Example 7 | | | | | | | |
| Comparative | Cu whisker | 150 | 150 | 1 | 2.9 | 80% | 60% |
| Example 8 | | | | | | | |
| Comparative | Titanium | 20 | 6 | 0.3 | 2.9 | 75% | 65% |
| Example 9 | oxide | | | | | | |
| Comparative | Titanium | 20 | 22 | 1.1 | 2.9 | 74% | 66% |
| Example 10 | oxide | | | | | | |
| Comparative | Titanium | 19 | 11.4 | 0.6 | 2.9 | 75% | 65% |
| Example 11 | oxide | | | | | | |
| Comparative | Titanium | 151 | 90.6 | 0.6 | 2.9 | 73% | 67% |
| Example 12 | oxide | | | | | | |
| Comparative | Carbon fiber | 19 | 5.7 | 0.3 | 2.9 | 64% | 69% |
| Example 13 | | | | | | | |
| Comparative | Carbon fiber | 19 | 20.9 | 1.1 | 2.9 | 65% | 68% |
| Example 14 | | | | | | | |
| Comparative | Carbon fiber | 151 | 45.3 | 0.3 | 2.9 | 68% | 67% |
| Example 15 | | | | | | | |
| Comparative | Carbon fiber | 151 | 166.1 | 1.1 | 2.9 | 66% | 69% |
| Example 16 | | | | | | | |

The lithium-ion rechargeable batteries of Examples 1 to 44 all have a higher capacity retention rate than the lithium-ion rechargeable batteries of Comparative Examples 1 to 16.

In Comparative Examples 1 to 4 and Comparative Examples 13 to 16, in which carbon fibers were used, the capacity retention rate was low as compared with that of the lithium-ion rechargeable batteries of Examples 1 to 44. This is conceived to be because the carbon fiber is soft as compared with an inorganic material such as a ceramic, and thus the effect of reinforcing the negative electrode active material layer 34 has not been sufficiently obtained.

In Comparative Examples 5 to 8, in which Cu whiskers were used, the capacity retention rate was low as compared with that of the lithium-ion rechargeable batteries of Examples 1 to 44. This is conceived to be because the metal material has ductility and is easily extended, and slippage easily occurs in the crystal structure, and thus the effect of reinforcing the negative electrode active material layer 34 has not been sufficiently obtained.

In Comparative Examples 9 to 12, in which the size of the fibrous material was not appropriate, the capacity retention rate was low as compared with that of the lithium-ion rechargeable batteries of Examples 1 to 44. This is conceived to be because the fibrous material was unable to function sufficiently as a skeleton for reinforcing the negative electrode active material layer 34.

### REFERENCE SIGNS LIST

1 Negative electrode active material
2 Fibrous material
3 Conductive auxiliary agent
10 Separator
20 Positive electrode
22 Positive electrode current collector
24 Positive electrode active material layer
30 Negative electrode
32 Negative electrode current collector
34 Negative electrode active material layer
40 power generation element
50 Exterior body
52 Metal foil
54 Resin layer
60, 62 Terminal
100 Lithium-ion rechargeable battery

1. A negative electrode active material layer comprising:
a negative electrode active material; and
a fibrous material,
wherein the negative electrode active material contains silicon,
the fibrous material contains at least one kind selected from the group consisting of titanium oxide, potassium titanate, aluminum oxide, silicon carbide, silicon nitride, and silicon oxide,
a fiber length of the fibrous material is 20 μm or more and 150 μm or less, and
a value obtained by dividing a thickness of the negative electrode active material layer by the fiber length is 0.4 or more and 1.0 or less.

2. The negative electrode active material layer according to claim 1, wherein an average interparticle distance of the negative electrode active material is 3.0 μm or more and 4.5 μm or less.

3. The negative electrode active material layer according to claim 1, wherein the fibrous material contains one or more kinds selected from the group consisting of titanium oxide, potassium titanate, and aluminum oxide.

4. The negative electrode active material layer according to claim 1, wherein the negative electrode active material contains the silicon as a simple body, a silicon alloy, a silicon compound, or a silicon composite body.

5. The negative electrode active material layer according to claim 4, wherein the silicon alloy is represented by XₙSi, wherein X is Ba, Mg, Al, Zn, Sn, Ca, V, Cr, Mn, Fe, Co, Ni, Cu, Zn, Ge, Y, Zr, Nb, Mo, W, Au, Ti, Na, or K, and n satisfies 0<n<0.5.

6. The negative electrode active material layer according to claim 4, wherein the silicon compound is a silicon oxide denoted as SiOₓ, wherein x satisfies 0.8≤x≤2.

7. The negative electrode active material layer according to claim 4, wherein the silicon composite body is one that is obtained by coating, with a conductive material, at least a part of a surface of a particle of silicon or a silicon compound, and the conductive material is a carbon material, Al, Ti, Fe, Ni, Cu, Zn, Ag, or Sn.

8. The negative electrode active material layer according to claim 1, wherein an average particle diameter of the negative electrode active material is 0.1 μm or more and 10 μm or less.

9. The negative electrode active material layer according to claim 8, wherein the average particle diameter of the negative electrode active material is 0.5 μm or more and 8 μm or less.

10. The negative electrode active material layer according to claim 9, wherein the average particle diameter of the negative electrode active material is 1 μm or more and 7 μm or less.

11. The negative electrode active material layer according to claim 1, wherein the fibrous material includes a material different from the negative electrode active material.

12. The negative electrode active material layer according to claim 1, wherein the fibrous material accounts for 1% or more and 20% or less of a total mass of the negative electrode active material layer.

13. The negative electrode active material layer according to claim 1, wherein the thickness of the negative electrode active material layer is 8 μm or more and 150 μm or less.

14. The negative electrode active material layer according to claim 1, further comprising a conductive auxiliary agent and a binder.

15. The negative electrode active material layer according to claim 14, wherein the conductive auxiliary agent is a carbon powder, a carbon nanotube, a carbon material, a metal fine powder, a mixture of a carbon material and a metal fine powder, or a conductive oxide.

16. The negative electrode active material layer according to claim 14, wherein the binder is a fluororesin.

17. The negative electrode active material layer according to claim 14, wherein the binder is cellulose, styrene-butadiene rubber, ethylene-propylene rubber, a polyimide resin, a polyamide-imide resin, or an acrylic resin.

18. The negative electrode active material layer according to claim 17, wherein the cellulose is carboxymethyl cellulose.

19. A negative electrode comprising the negative electrode active material layer according to claim 1.

20. A lithium-ion rechargeable battery comprising:
the negative electrode according to claim 19;
a positive electrode facing the negative electrode; and
an electrolyte connecting the negative electrode and the positive electrode.
